(19) United States
(12) Patent Application Publication
(10) Pub. No.: US 2021/0135753 A1
(43) Pub. Date: May 6, 2021

(54) DETECTING CODED LIGHT

(71) Applicant: SIGNIFY HOLDING B.V., EINDHOVEN (NL)

(72) Inventors: Stephanus Joseph Johannes NIJSSEN, EINDHOVEN (NL); Harry BROERS, EINDHOVEN (NL); Constant Paul Marie Jozef BAGGEN, EINDHOVEN (NL); Paul Henricus Johannes Maria VAN VOORTHUISEN, EINDHOVEN (NL)

(21) Appl. No.: 16/471,577

(22) PCT Filed: Dec. 14, 2017
(86) PCT No.: PCT/EP2017/082790

§ 371 Date: Jun. 20, 2019

(30) Foreign Application Priority Data
Dec. 22, 2016 (EP) 16206112.1

(51) Int. Cl. H04B 10/116; H04B 10/114; H05B 47/195; H04N 5/353

(52) U.S. Cl. CPC H04B 10/116; H04N 5/3532; H05B 47/195; H04B 10/1141

(57) ABSTRACT

A series of frames is captured by a rolling-shutter camera, each frame capturing an image of a light source which has a periodic message embedded in its light. With a rolling-shutter camera, each line captures a respective sample of the message and each frame captures a respective fragment of the message made up of a respective subsequence of the samples, wherein the message can be reconstructed from the fragments captured over multiple frames. Further, the frame rate of the rolling-shutter camera is dependent on a region of interest (ROI), and the method further comprises evaluating a metric indicative of how long will be required to accumulate enough fragments to reconstruct the message at the current frame rate, and adapting the ROI in dependence on this metric in order to change the frame rate and thereby reduce the number of subsequent frames required to complete the reconstruction of the message.

### TECHNICAL FIELD

The present disclosure relates to the communication of coded light signals embedded in the light emitted by a light source.

### BACKGROUND

Visible light communication (VLC) refers to techniques whereby information is communicated in the form of a signal embedded in the visible light emitted by a light source. VLC is sometimes also referred to as coded light.

The signal is embedded by modulating a property of the visible light, typically the intensity, according to any of a variety of suitable modulation techniques. In some of the simplest cases, the signaling is implemented by modulating the intensity of the visible light from each of multiple light sources with a single periodic carrier waveform or even a single tone (sinusoid) at a constant, predetermined modulation frequency. If the light emitted by each of the multiple light sources is modulated with a different respective modulation frequency that is unique amongst those light sources, then the modulation frequency can serve as an identifier (ID) of the respective light source or its light.

In more complex schemes a sequence of data symbols may be modulated into the light emitted by a given light source. The symbols are represented by modulating any suitable property of the light, e.g. amplitude, modulation frequency, or phase of the modulation. For instance, data may be modulated into the light by means of amplitude keying, e.g. using high and low levels to represent bits or using a more complex modulation scheme to represent different symbols. Another example is frequency keying, whereby a given light source is operable to emit on two (or more) different modulation frequencies and to transmit data bits (or more generally symbols) by switching between the different modulation frequencies. As another possibility a phase of the carrier waveform may be modulated in order to encode the data, i.e. phase shift keying.

In general the modulated property could be a property of a carrier waveform modulated into the light, such as its amplitude, frequency or phase; or alternatively a baseband modulation may be used. In the latter case there is no carrier waveform, but rather symbols are modulated into the light as patterns of variations in the brightness of the emitted light. This may for example comprise modulating the intensity to represent different symbols, or modulating the mark:space ratio of a pulse width modulation (PWM) dimming waveform, or modulating a pulse position (so-called pulse position modulation, PPM). The modulation may involve a coding scheme to map data bits (sometimes referred to as user bits) onto such channel symbols. An example is a conventional Manchester code, which is a binary code whereby a user bit of value 0 is mapped onto a channel symbol in the form of a low-high pulse and a user bit of value 1 is mapped onto a channel symbol in the form of a high-low pulse. Another example coding scheme is the so-called Ternary Manchester code developed by the applicant, and disclosed in U.S. Pat. No. 9,356,696 B2.

Based on the modulations, the information in the coded light can be detected using any suitable light sensor. This can be either a dedicated photocell (point detector), or a camera comprising an array of photocells (pixels) and a lens for forming an image on the array. E.g. the camera may be a general purpose camera of a mobile user device such as a smartphone or tablet. Camera based detection of coded light is possible with either a global-shutter camera or a rolling-shutter camera. E.g. rolling-shutter readout is typical to mobile CMOS image sensors found in everyday mobile user devices such as smartphones and tablets). In a global-shutter camera the entire pixel array (entire frame) is captured at the same time, and hence a global shutter camera captures only one temporal sample of the light from a given luminaire per frame. In a rolling-shutter camera on the other hand, the frame is divided into lines in the form of horizontal rows and the frame is exposed line-by-line in a temporal sequence, each line in the sequence being exposed at a slightly later time than the last. Each line therefore captures a sample of the signal at a different moment in time. Hence while rolling-shutter cameras are generally the cheaper variety and considered inferior for purposes such as photography, for the purpose of detecting coded light they have the advantage of capturing more temporal samples per frame, and therefore a higher sample rate for a given frame rate. Nonetheless coded light detection can be achieved using either a global-shutter or rolling-shutter camera as long as the sample rate is high enough compared to the modulation frequency or data rate (i.e. high enough to detect the modulations that encode the information).

Coded light is often used to embed a signal in the light emitted by an illumination source such as an everyday luminaire, e.g. room lighting or outdoor lighting, thus allowing the illumination from the luminaires to double as a carrier of information. The light thus comprises both a visible illumination contribution for illuminating a target environment such as room (typically the primary purpose of the light), and an embedded signal for providing information into the environment (typically considered a secondary function of the light). In such cases, the modulation is typically performed at a high enough frequency so as to be beyond human perception, or at least such that any visible temporal light artefacts (e.g. flicker and/or strobe artefacts) are weak enough not to be noticeable or at least to be tolerable to humans. Thus the embedded signal does not affect the primary illumination function, i.e. so the user only perceives the overall illumination and not the effect of the data being modulated into that illumination. E.g. Manchester coding is an example of a DC free code, wherein the power spectral density goes to zero at zero Hertz, with very little spectral content at low frequencies, thus reducing visible flicker to a practically invisible level. Ternary Manchester is DC² free, meaning not only does the power spectral density go to zero at zero Hertz, but the gradient of the power spectral density also goes to zero, thus eliminating visible flicker even further.

Coded light can be used in a variety of possible applications. For instance a different respective ID can be embedded into the illumination emitted by each of the luminaires in a given environment, e.g. those in a given building, such that each ID is unique at least within the environment in question. E.g. the unique ID may take the form of a unique modulation frequency or unique sequence of symbols. This in itself can then enable any one or more of a number of applications. For instance, one application is to provide information from a luminaire to a remote control unit for control purposes, e.g. to provide an ID distinguishing it amongst other such luminaires which the remote unit can control, or to provide status information on the luminaire (e.g. to report errors, warnings, temperature, operating time, etc.). For example the remote control unit may take the form of a mobile user terminal such as a smartphone, tablet, smartwatch or smart-glasses equipped with a light sensor such as a built-in camera. The user can then direct the sensor toward a particular luminaire or subgroup of luminaires so that the mobile device can detect the respective ID(s) from the emitted illumination captured by the sensor, and then use the detected ID(s) to identify the corresponding one or more luminaires in order to control it/them (e.g. via an RF back channel). This provides a user-friendly way for the user to identify which luminaire or luminaires he or she wishes to control. The detection and control may be implemented by a lighting control application or “app” running on the user terminal.

In another application the coded light may be used in commissioning. In this case, the respective IDs embedded in the light from the different luminaires can be used in a commissioning phase to identify the individual illumination contribution from each luminaire.

In another example, the identification can be used for navigation or other location-based functionality, by mapping the identifier to a known location of a luminaire or information associated with the location. In this case, there is provided a location database which maps the coded light ID of each luminaire to its respective location (e.g. coordinates on a map or floorplan), and this database may be made available to mobile devices from a server via one or more networks such as a wireless local area network (WLAN) or mobile cellular network, or may even be stored locally on the mobile device. Then if the mobile device captures an image or images containing the light from one or more of the luminaires, it can detect their IDs and use these to look up their locations in the location database in order to estimate the location of the mobile device based thereon. E.g. this may be achieved by measuring a property of the received light such as received signal strength, time of flight and/or angle of arrival, and then applying technique such as triangulation, trilateration, multilateration or fingerprinting; or simply by assuming that the location of the nearest or only captured luminaire is approximately that of the mobile device. In some cases such information may be combined with information from other sources, e.g. on-board accelerometers, magnetometers or the like, in order to provide a more robust result. The detected location may then be output to the user through the mobile device for the purpose of navigation, e.g. showing the position of the user on a floorplan of the building. Alternatively or additionally, the determined location may be used as a condition for the user to access a location based service. E.g. the ability of the user to use his or her mobile device to control the lighting (or another utility such as heating) in a certain region or zone (e.g. a certain room) may be made conditional on the location of his or her mobile device being detected to be within that same region (e.g. the same room), or perhaps within a certain control zone associated with the lighting in question. Other forms of location-based service may include, e.g., the ability to make or accept location-dependent payments.

As another example application, a database may map luminaire IDs to location specific information such as information on a particular museum exhibit in the same room as a respective one or more luminaires, or an advertisement to be provided to mobile devices at a certain location illuminated by a respective one or more luminaires. The mobile device can then detect the ID from the illumination and use this to look up the location specific information in the database, e.g. in order to display this to the user of the mobile device. In further examples, data content other than IDs can be encoded directly into the illumination so that it can be communicated to the receiving device without requiring the receiving device to perform a look-up.

Thus coded light has various commercial applications in the home, office or elsewhere, such as a personalized lighting control, indoor navigation, location based services, etc.

As mentioned above, coded light can be detected using an everyday “rolling shutter” type camera, as is often integrated into an everyday mobile user device like a mobile phone or tablet. In a rolling-shutter camera, the camera's image capture element is divided into a plurality of horizontal lines (i.e. rows) which are exposed in sequence line-by-line. That is, to capture a given frame, first one line is exposed to the light in the target environment, then the next line in the sequence is exposed at a slightly later time, and so forth. Each line therefore captures a sample of the signal at a different moment in time (typically with the pixels from each given line being condensed into a single sample value per line). Typically the sequence “rolls” in order across the frame, e.g. in rows top to bottom, hence the name “rolling shutter”. When used to capture coded light, this means different lines within a frame capture the light at different moments in time and therefore, if the line rate is high enough relative to the modulation frequency, at different phases of the modulation waveform. Thus the rolling-shutter readout causes fast temporal light modulations to translate into spatial patterns in the line-readout direction of the sensor, from which the encoded signal can be decoded.

Because a rolling-shutter camera captures each frame line-by-line in a sequence, this means that when a rolling-shutter camera is used to capture a coded light signal comprising a cyclically repeated message, each line captures a respective sample of the message and each frame captures a respective fragment of the message, each fragment made up of a respective subsequence of the samples. For most combinations of frame rate and message repetition period, the frame rate and message duration have no particular relationship between one another. This is desirable since it means that each frame sees a different fragment of the message, and the signal can then be reconstructed from the different fragments. Techniques for this so-called “stitching” together of message fragment are known to the skilled person from international patent application publication number WO2015/121155.

However, by unfortunate coincidence, a combination of message period and frame rate sometimes occurs such that each frame sees the same fragment over and over, whilst another part of the message is never captured. In other words the “rolling condition” of WO2015/121155 is not met. E.g. this occurs if the frame period (1/framerate) is an integer multiple of the message period (1/message repetition rate), or close to an integer multiple.

### SUMMARY

For this reason it would be desirable if the receiver could control the frame rate, in order to avoid that the combination of the frame rate and message duration fails to meet the rolling condition. However, the frame rate is typically not a controllable parameter of a camera, or at least not controllable by a coded light detector (e.g. a third party application running on the camera device). Nonetheless, the inventors have recognized that in many rolling-shutter cameras support a region of interest (ROI) feature whereby only a certain sub region of the frame area is captured. Further, in such cameras, the frame rate is often a function of the size of the region of interest (typically at least a function of the vertical size, i.e. the size in the rolling direction perpendicular to the lines, since this affects how many lines need to be exposed). Moreover, the region of interest is a setting that can be controlled by a third-party application or the like. Hence the inventors have made the connection that the ROI can be used to indirectly influence the frame rate in order to ensure message capture within a certain number of frames.

According to one aspect disclosed herein, there is provided apparatus for detecting a message transmitted periodically in light emitted by a light source, the apparatus comprising: a detector and a controller. The detector is configured to receive a series of frames captured at a frame rate by a rolling-shutter camera, each frame capturing an image of the light source, wherein the rolling-shutter camera captures each of the frames over a range of sequentially captured lines such that each line captures a respective sample of the message and each frame captures a respective fragment of the message made up of a respective subsequence of the samples, and wherein the detector is configured to reconstruct the message from the fragments captured over a plural number of said frames. The controller is operable to set a region of interest of the rolling-shutter camera, wherein the frame rate of the rolling-shutter camera is dependent on a size of the region of interest. The controller is configured to evaluate a metric indicative of how long will be required to accumulate enough of said fragments to reconstruct the message at a current value of said frame rate, and to adapt the region of interest in dependence on the evaluated metric in order to change the frame rate and thereby reduce the number of subsequent frames required to complete the reconstruction of the message.

In embodiments, said metric may comprise a current number of said frames that have been captured, or a time that has currently elapsed, without yet accumulating enough of said fragments to allow for said reconstruction of the message.

Alternatively said metric may comprise a measure of similarity between the message fragments from two or more of said frames within a predetermined number of frames of one another in said series.

In embodiments, the controller may be configured to perform said adaption of the region of interest by adapting a size of the region of interest in a direction perpendicular to the lines, thereby adapting the range of lines captured per frame.

In particularly advantageous embodiments, further measures may be taken to facilitate the reliable and/or timely capture of a coded light signal.

For instance in embodiments, the controller may be configured to perform said adaption of the region of interest by adapting a size of the region of interest in a direction parallel to said lines.

In embodiments, the controller may be configured to perform said adaption of the region of interest by adapting a subsampling or binning ratio of the frames.

In embodiments, the controller may be further configured to adapt the size of the region of interest perpendicular to said lines in dependence on a signal to noise ratio of the reconstructed message.

In embodiments, the controller may be configured to initially set the region of interest to an initial region of interest which crops the frames around a footprint of the light source in at least a direction perpendicular to said lines; and to perform said monitoring under conditions of the initial region of interest, said adaption being relative to the initial region of interest.

In embodiments, the controller may be configured to control the region of interest so as, before and after said adaption, to leave a margin around at least part of the footprint; and to track the footprint of the light source at least partially based on part of the footprint moving into the margin in a successive one of said frames.

In embodiments, the controller may be configured to leave said margin all around the footprint.

In embodiments, the camera may support multiple regions of interest, and the controller may be configured to track motion of the footprint at least in part by using the multiple regions of interest to anticipate the tracked motion.

In an exemplary application of the disclosed techniques, the message comprises an ID of the light source and the detector is configured to decode the ID from the reconstructed message; and wherein the apparatus further comprises a localization module configured to look up a location of the light source based on the decoded ID, and to estimate a location of the camera based at least in part on the location of the light source as looked up based on the decoded ID.

According to another aspect disclosed herein, there is provided receiver equipment comprising the apparatus of any preceding claim and further comprising the camera.

According to another aspect disclosed herein, there is provided a system comprising the receiving equipment and further comprising transmitting equipment, the transmitting equipment comprising said light source.

According to another aspect disclosed herein, there is provided a method of detecting a message transmitted periodically in light emitted by a light source, the method comprising: receiving a series of frames captured at a frame rate by a rolling-shutter camera, each frame capturing an image of the light source, wherein the rolling-shutter camera captures each of the frames over a range of sequentially captured lines such that each line captures a respective sample of the message and each frame captures a respective fragment of the message made up of a respective subsequence of the samples; and reconstructing the message from the fragments captured over a plural number of said frames; wherein the frame rate of the rolling-shutter camera is dependent on a size of the region of interest; and wherein the method further comprises evaluating a metric indicative of how long will be required to accumulate enough of said fragments to reconstruct the message at a current value of said frame rate, and adapting the region of interest in dependence on the evaluated metric in order to change the frame rate and thereby reduce the number of subsequent frames required to complete the reconstruction of the message.

According to another aspect disclosed herein, there is provided a computer program product for detecting a message transmitted periodically in light emitted by a light source, the computer program product comprising code embodied on computer-readable storage and/or being downloadable therefrom, and being configured so as when run on a processing apparatus comprising one or more processing units to perform operations of: receiving a series of frames captured at a frame rate by a rolling-shutter camera, each frame capturing an image of the light source, wherein the rolling-shutter camera captures each of the frames over a range of sequentially captured lines such that each line captures a respective sample of the message and each frame captures a respective fragment of the message made up of a respective subsequence of the samples; and reconstructing the message from the fragments captured over a plural number of said frames; wherein the frame rate of the rolling-shutter camera is dependent on a size of the region of interest; and wherein the code is further configured so as when run on the processing apparatus to evaluate a metric indicative of how long will be required to accumulate enough of said fragments to reconstruct the message at a current value of said frame rate, and to adapt the region of interest in dependence on the evaluated metric in order to change the frame rate and thereby reduce the number of subsequent frames required to complete the reconstruction of the message.

### BRIEF DESCRIPTION OF THE DRAWINGS

To assist understanding of the present disclosure and to show how embodiments may be put into effect, reference is made by way of example to the accompanying drawings in which:

FIG. 1 is a schematic block diagram of a coded light communication system,

FIG. 2 is a schematic representation of a frame captured by a rolling shutter camera,

FIG. 2a is a timing diagram showing the line readout of a rolling shutter camera,

FIG. 2b schematically illustrates the phenomenon of blanking when capturing a frame,

FIG. 3 schematically illustrates an image capture element of a rolling-shutter camera,

FIG. 4 schematically illustrates the capture of modulated light by rolling shutter,

FIG. 5 is a schematic block diagram of a coded light receiver,

FIG. 6 is a schematic illustration of the footprint of a luminaire in a captured image,

FIG. 7 is a timing diagram illustrating message reconstruction from multiple fragments,

FIG. 8 is a plot of number of frames needed to capture a message vs. message duration,

FIG. 9 schematically illustrates the application of a region-of-interest (ROI),

FIG. 10 is a timing diagram showing message reconstruction using an adapted ROI.

### DETAILED DESCRIPTION OF EMBODIMENTS

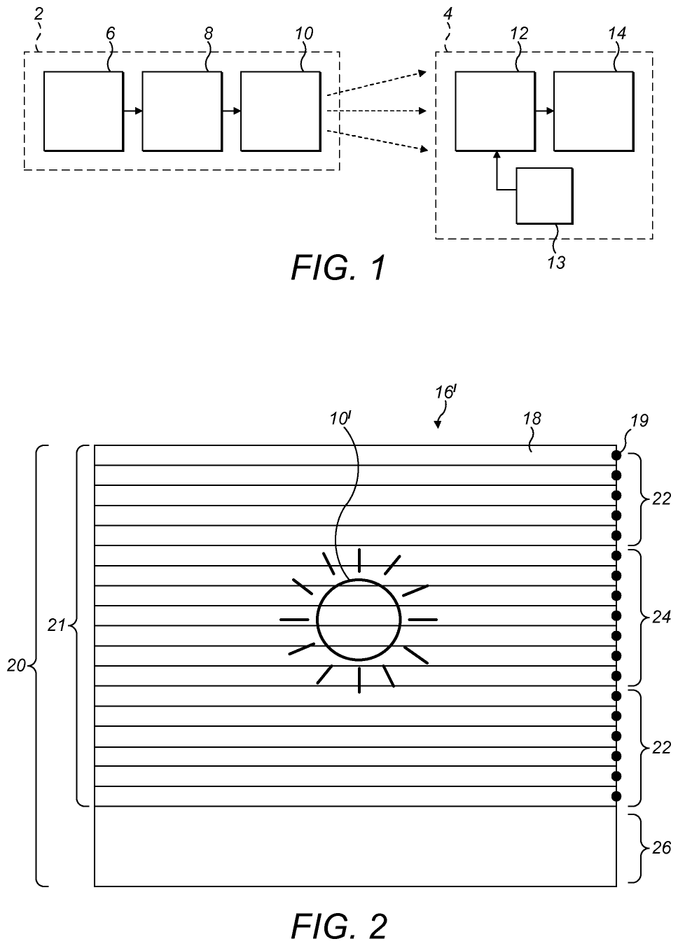

FIG. 1 gives a schematic overview of a system for transmitting and receiving coded light. The system comprises a transmitter 2 and a receiver 4. For example the transmitter 2 may take the form of a luminaire, e.g. mounted on the ceiling or wall of a room, or taking the form of a free-standing lamp, or an outdoor light pole. The receiver 4 may for example take the form of a mobile user terminal such as a smart phone, tablet, laptop computer, smartwatch, or a pair of smart-glasses.

The transmitter 2 comprises a light source 10 and a driver 8 connected to the light source 10. In the case were the transmitter 2 comprises a luminaire, the light source 10 takes the form of an illumination source (i.e. lamp) configured to emit illumination on a scale suitable for illuminating an environment such as a room or outdoor space, in order to allow people to see objects and/or obstacles within the environment and/or find their way about. The illumination source 10 may take any suitable form such as an LED-based lamp comprising a string or array of LEDs, or potentially another form such as a fluorescent lamp. The transmitter 2 also comprises an encoder 6 coupled to an input of the driver 8, for controlling the light source 10 to be driven via the driver 8. Particularly, the encoder 6 is configured to control the light source 10, via the diver 8, to modulate the illumination it emits in order to embed a cyclically repeated coded light message. Any suitable known modulation technique may be used to do this. In embodiments the encoder 6 is implemented in the form of software stored on a memory of the transmitter 2 and arranged for execution on a processing apparatus of the transmitter (the memory on which the software is stored comprising one or more memory units employing one or more storage media, e.g. EEPROM or a magnetic drive, and the processing apparatus on which the software is run comprising one or more processing units). Alternatively it is not excluded that some or all of the encoder 6 could be implemented in dedicated hardware circuitry, or configurable or reconfigurable hardware circuitry such as a PGA or FPGA.

The receiver 4 comprises a camera 12 and a coded light detector 14 coupled to an input from the camera 12 in order to receive images captured by the camera 12. The receiver 4 also comprises a controller 13 which is arranged to control the exposure of the camera 12. In embodiments, the detector 14 and controller 13 are implemented in the form of software stored on a memory of the receiver 4 and arranged for execution on a processing apparatus of the receiver 4 (the memory on which the software is stored comprising one or more memory units employing one or more storage media, e.g. EEPROM or a magnetic drive, and the processing apparatus on which the software is run comprising one or more processing units). Alternatively it is not excluded that some or all of the detector 14 and/or controller 13 could be implemented in dedicated hardware circuitry, or configurable or reconfigurable hardware circuitry such as a PGA or FPGA.

The encoder 6 is configured to perform the transmit-side operations in accordance with embodiments disclosed herein, and the detector 14 and controller 13 are configured to perform the receive-side operations in accordance with the disclosure herein. Note also that the encoder 6 need not necessarily be implemented in the same physical unit as the light source 10 and its driver 8. In embodiments the encoder 6 may be embedded in a luminaire along with the driver and light source. Alternatively the encoder 6 could be implemented externally to the luminaire 4, e.g. on a server or control unit connected to the luminaire 4 via any one or more suitable networks (e.g. via the internet, or via a local wireless network such as a Wi-Fi or ZigBee, 6LowPAN or Bluetooth network, or via a local wired network such as an Ethernet or DMX network). In the case of an external encoder, some hardware and/or software may still be provided on board the luminaire 4 to help provide a regularly timed signal and thereby prevent jitter, quality of service issues, etc.

Similarly the coded light detector 14 and/or controller 13 are not necessarily implemented in the same physical unit as the camera 12. In embodiments the detector 14 and controller 13 may be incorporated into the same unit as the, e.g. incorporated together into a mobile user terminal such as a smartphone, tablet, smartwatch or pair of smart-glasses (for instance being implemented in the form of an application or “app” installed on the user terminal). Alternatively, the detector 14 and/or controller 13 could be implemented on an external terminal. For instance the camera 12 may be implemented in a first user device such as a dedicated camera unit or mobile user terminal like a smartphone, tablet, smartwatch or pair of smart glasses; whilst the detector 14 and controller 13 may be implemented on a second terminal such as a laptop, desktop computer or server connected to the camera 12 on the first terminal via any suitable connection or network, e.g. a one-to-one connection such as a serial cable or USB cable, or via any one or more suitable networks such as the Internet, or a local wireless network like a Wi-Fi or Bluetooth network, or a wired network like an Ethernet or DMX network. Nonetheless, in embodiments local processing may be preferred. E.g. transmitting raw video images at VGA resolution would require a bit rate of 40 pixels*480 lines*30 frames*8 bits=˜74 Mbit/s, so the network would need to support that if the images are to be processed externally to the device comprising the camera 12.

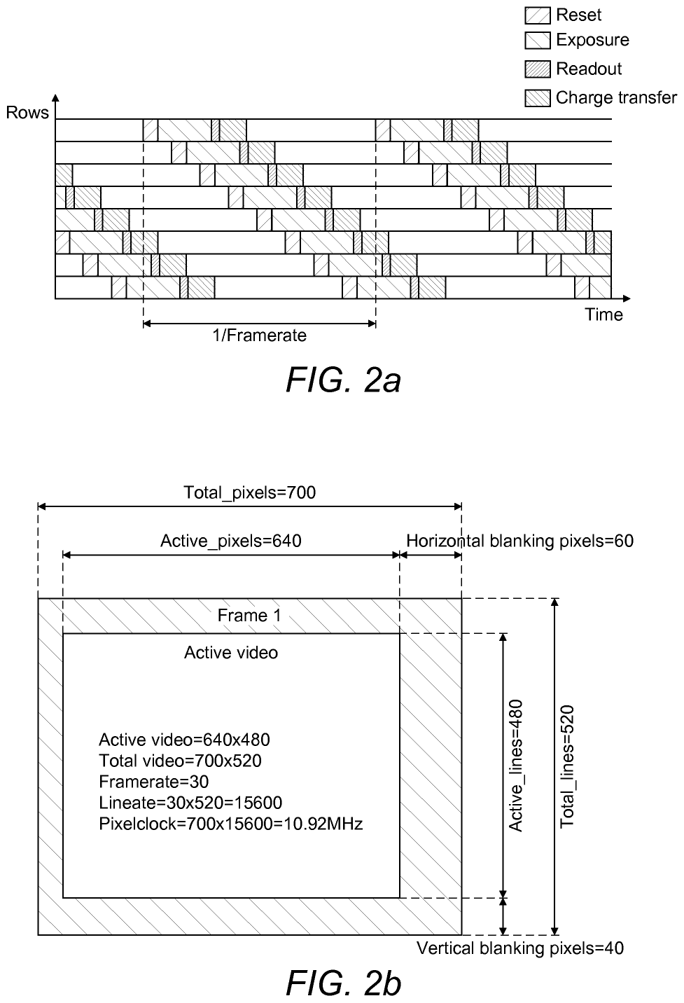

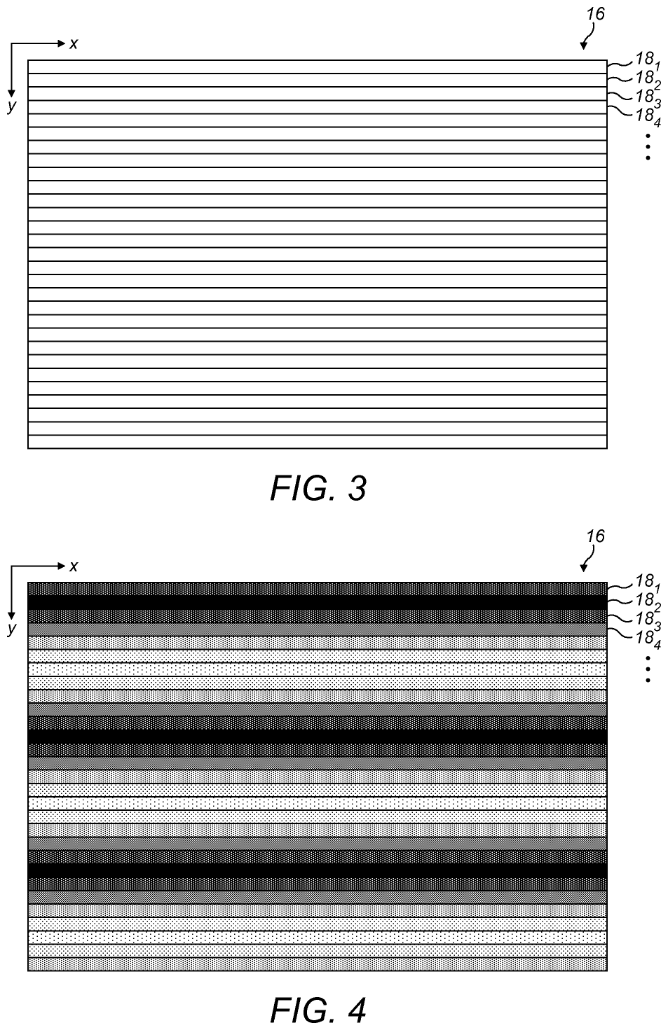

FIG. 3 represents the image capture element 16 of the camera 12, which takes the form of a rolling-shutter camera. The image capture element 16 comprises an array of pixels for capturing signals representative of light incident on each pixel, e.g. typically a square or rectangular array of square or rectangular pixels. In a rolling-shutter camera, the pixels are arranged into a plurality of lines in the form of horizontal rows 18. To capture a frame each line is exposed in sequence, each for a successive instance of the camera's exposure time Texp. In this case the exposure time is the duration of the exposure of an individual line. Note of course that in the context of a digital camera, the terminology “expose” or “exposure” does not refer to a mechanical shuttering or such like (from which the terminology historically originated), but rather the time when the line is actively being used to capture or sample the light from the environment. Note also that a sequence in the present disclosure means a temporal sequence, i.e. so the exposure of each line starts at a slightly different time. This does not exclude that optionally the exposure of the lines may overlap in time, i.e. so the exposure time Texp is longer than the line time (1/line rate), and indeed typically this is more often the case. This is illustrated in FIG. 2a. For example first the top row 18₁ begins to be exposed for duration Texp, then at a slightly later time the second row down 18₂ begins to be exposed for Texp, then at a slightly later time again the third row down 18₃ begins to be exposed for Texp, and so forth until the bottom row has been exposed. This process is then repeated in order to expose a sequence of frames.

Coded light can be detected using a conventional video camera of this type. The signal detection exploits the rolling shutter image capture, which causes temporal light modulations to translate to spatial intensity variations over successive image rows.

This is illustrated schematically FIG. 4. As each successive line 18 is exposed, it is exposed at a slightly different time and therefore (if the line rate is high enough compared to the modulation frequency) at a slightly different phase of the modulation. Thus each line 18 is exposed to a respective instantaneous level of the modulated light. This results in a pattern of stripes which undulates or cycles with the modulation over a given frame. Based on this principle, the image analysis module 14 is able to detect coded light components modulated into light received by the camera 10.

For coded light detection, a camera with a rolling-shutter image sensor has an advantage over global-shutter readout (where a whole frame is exposed at once) in that the different time instances of consecutive sensor lines causes fast light modulations to translate to spatial patterns as discussed in relation to FIG. 4. However unlike shown in FIG. 4, the light (or at least the useable light) from a given light source 4 does not necessarily cover the area of the whole image capture element 16, but rather only a certain footprint. As a consequence, the shorter the vertical spread of a captured light footprint, the longer the duration over which the coded light signal is detectable. In practice, this means only a temporal fragment of the entire coded light signal can be captured within a single frame, such that multiple frames are required in order to capture sufficient shifted signal fragments to recover the data embedded in the coded light. The smaller the signal fragment in each frame, the more captured frames are necessary before data recovery is possible.

Referring to FIG. 2, the camera 12 is arranged to capture a series of frames 16′, which if the camera is pointed towards the light source 10 will contain an image 10′ of light from the light source 10. As discussed, the camera 12 is a rolling shutter camera, which means it captures each frame 16′ not all at once (as in a global shutter camera), but by line-by-line in a sequence of lines 18. That is, each frame 16 is divided into a plurality of lines 18 (the total number of lines being labelled 20 in FIG. 2), each spanning across the frame 16 and being one or more pixels thick (e.g. spanning the width of the frame 16 and being one or more pixels high in the case of horizontal lines). The capture process begins by exposing one line 18, then the next (typically an adjacent line), then the next, and so forth. For example the capturing process may roll top-to-bottom of the frame 16′, starting by exposing the top line, then then next line from top, then the next line down, and so forth. Alternatively it could roll bottom-to-top, or even side to side. Of course if the camera 12 is included in a mobile or movable device such that it can be oriented in different directions, the orientation of the lines relative to an external frame of reference is variable. Hence as a matter or terminology, the direction perpendicular to the lines in the plane of the frame (i.e. the rolling direction, also referred to as the line readout direction) will be referred to as the vertical direction; whilst the direction parallel to the lines in the plane of the frame 16′ will be referred to as the horizontal direction.

To capture a sample for the purpose of detecting coded light, some or all of the individual pixels samples of each given line 18 are combined into a respective combined sample 19 for that line (e.g. only the “active” pixels that usefully contribute to the coded light signal are combined, whilst the rest of the pixels from that line are discarded). For instance the combination may be performed by integrating or averaging the pixel values, or by any other combination technique. Alternatively a certain pixel could be taken as representative of each line. Either way, the samples from each line thus form a temporal signal sampling the coded light signal at different moments in time, thus enabling the coded light signal to be detected and decoded from the sampled signal.

For completeness, note that the frame 16 may also include some blanking lines 26. Typically the line rate is somewhat higher than strictly needed for all active lines: the actual number of lines of the image sensor). The clock scheme of an image sensor uses the pixel clock as the highest frequency, and framerate and line rate are derived from that. This typically gives some horizontal blanking every line, and some vertical blanking every frame. See FIG. 2b as an example. The lines ‘captured’ in that time are called blanking lines and do not contain data.

Note also, as well as dedicated rolling-shutter cameras, there also exist CMOS imagers that support both rolling shutter and global shutter modes. E.g. these sensors are also used in some 3D range cameras, such as may soon be incorporated in some mobile devices. The term “rolling-shutter camera” as used herein refers to any camera having rolling shutter capability, and does not necessarily limit to a camera that can only perform rolling-shutter capture.

A challenge with coded light detection is that the light source 10 does not necessarily cover all or even almost all of every frame 16′. Moreover the light being emitted is not necessarily synchronized with the capturing process which can result in further problems.

A particular problem in using a rolling shutter camera 12 for coded light detection therefore arises, because the light source 10 serving as a coded light transmitter may in fact cover only a fraction of the lines 18 of each frame 16. Actually, only the lines 24 in FIG. 2 contain pixels that record the intensity variations of the coded light source and thus lead to samples containing useful information. All the remaining “lines per frame” 22 and their derived samples do not contain coded light information related to the source 10 of interest. If the source 10 is small, one may only obtain a short temporal view of the coded light source 10 in each frame 16 and therefore the existing techniques only allow for very short messages. However, it may be desirable to have the possibility of also transmitting longer messages.

Accordingly, techniques are known whereby the coded light message is repeated cyclically and the detector 14 at the receive side 4 is able to reconstruct or “stitch together” the individual fragments of the message seen over different frames. Such techniques are described in WO2015/121155. It is also not excluded that other known stitching techniques could be used.

However, as will be elaborated upon in more detail shortly, certain combinations of frame rate and message period (1/message repetition rate) result in the same fragments being seen over and over again, whilst other fragments are never seen or at least take a very long time to roll into view.

The following describes a method and apparatus for improving the detection of Visible Light Communication (VLC), i.e. coded light, by using the region-of-interest (ROI) settings of the camera 12 in order to influence the frame rate and thereby avoid non-rolling combinations of frame rate and message repetition period. In embodiments, the controller 13 of the receiver 4 first sets the ROI so as to use only the significant part(s) of the image where the light source(s) 10 with the embedded VLC message can be seen. As the frame rate of the camera 12 is dependent on the ROI, this increases the frame rate, and thereby significantly improves the detection speed and therefore the bandwidth of the channel. With the correct camera settings, the blanking can also increase with smaller ROI. Furthermore, by adjusting this ROI (by slightly increasing or decreasing its vertical size), the framerate can be influenced such that it is optimal for VLC detection, i.e. to avoid non-frame rates that do not satisfy the rolling condition for a given message repetition period. This is especially useful for inaccurate RC oscillator based drivers.

As mentioned, a VLC transmitter 2 suited for smartphone detection, or the like, typically transmits repeated instances of the same message because only a part of the camera image 16 is covered by the light source 10 when viewed by the camera 12 from a typical distance (e.g. a few meters). Therefore only a fraction of the message is received per image (i.e. per frame 16) and the detector 14 needs to collect the data from multiple frames. Here is where some problems may occur. Firstly, when the number of lines 24 covered by the light source 10 is small then it may take many frames to collect a message. Secondly, the detector needs to collect different parts of the message in order to fully receive the complete message. The message repetition rate is fixed and determined by the luminaire or transmitter 4 (e.g. acting as a beacon). The framerate of the camera 12 is typically also fixed, or at least is not a parameter that can be selected in its own right. However, the combination can lead to a so called non-rolling message. This means that the message rate and frame rate have such a ratio that some parts of the message are never ‘seen’ by the camera 12 (or equivalently the frame period and message repetition period have such a ratio that some parts of the message are never seen by the camera 12).

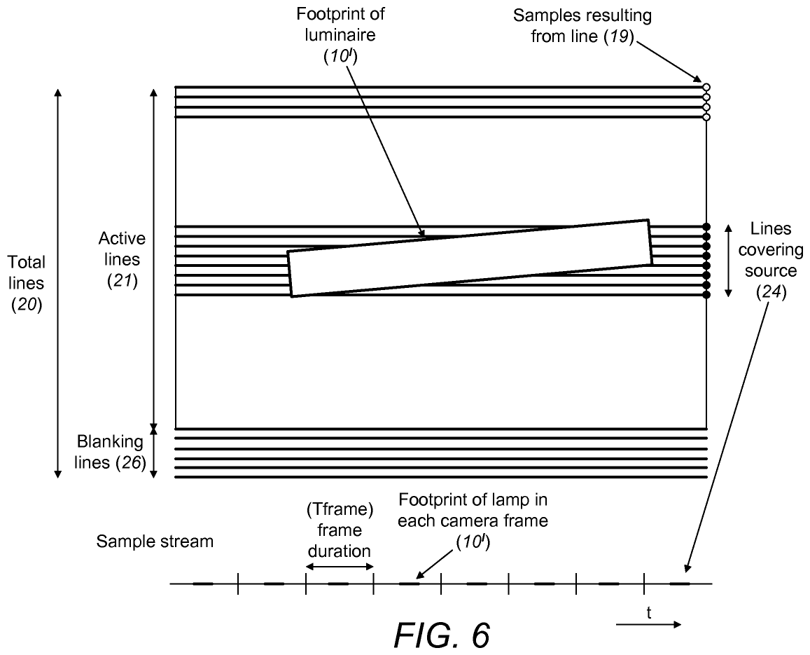

FIG. 6 shows a typical image of a light source 10 as seen by a rolling-shutter camera 12. The rolling shutter camera 12 samples every line 18 with a slight delay (1/the line rate) relative to the previously sampled line in the sequence, the sampling of the lines 18 typically rolling in sequence top-to-bottom or bottom-to-top. This means the temporal light variation of the coded light can be captured spatially (in the vertical direction). The lines labelled 18 in FIG. 6 indicate the camera lines, all lines are scanned during one frame time Tframe (=1/framerate). The rectangle illustrates a typical footprint 10′ of a light source 10. For coded light detection, the pixel values on one line are condensed into a sample per line, e.g. after pixel selection and averaging, as indicated schematically by the dots 19 at the right side (though in embodiments the 2D image may also still be used for purposes related to the detection, such as region segmentation and/or motion estimation). The lines that capture the light source 10 are labelled 24. The scanning of these lines lasts for a duration Tsource (<Tframe). The cyclically repeated message has an overall message repetition period (1/the message repetition rate) of Tmessage.

At the bottom of FIG. 6, the 1D sample stream as a function of time is shown. As also illustrated, only some of the samples per frame corresponding to the footprint 10′, where:

footprint ratio α=Tsource/Tframe

Typically, if there is no particular rational ratio between the frame rate and the message repetition rate, then each frame 16 (while scanning the footprint 10′ of the source 10) will capture a different partial view of the message that is cyclically transmitted by the source 10. By combining the footprints of sufficiently many consecutive frames the message can be reassembled (a process sometimes referred to as “stitching”, as known at least from WO2015/121155), then the detector 14 is able to reconstruct the complete message, provided that Tframe, a and the message duration satisfy certain properties as described further below. The number of frames (NO needed for stitching or reconstructing a complete message, is the main parameter which determines the decoding delay, i.e., the waiting time before a decoding result is available to the system.

As an intuitive example, consider the case where the frame period is an integer multiple of the message repetition period, e.g. equal to the message period (1×the message period). In the first frame to be captured, the scanning of the lines 24 covering the source 10 happens to coincide in time with a certain first fragment of the coded light message being emitted by the source—whatever portion of the message happens to be being transmitted at the time those particular lines 24 are being scanned. The in the next frame to be captured, the same lines 24 will be scanned again at a time Tframe later. If the next instance of the message is also repeated after a time Tmessage=Tframe (or ½Tframe, (⅓)Tframe etc.), then the lines 24 covering the footprint 10′ come to be scanned again, the same fragment of the message will have come around (assuming the footprint 10′ has not moved relative to the frame area 16). Thus the camera 12 will always see the same fragment of the message and always miss the rest of the message. On the other hand, say the message repetition period Tmessage is some arbitrary ratio of the frame period Tframe, e.g. Tmessage=(1/√2)Tframe. In this case, when the lines 24 covering the footprint 10′ come to be scanned again after a frame period Tframe, the message will have rolled around by some amount that is out of phase with the frame period. Hence that frame will see a different fragment of the message. As long as certain other relationships between frame period and message period do not occur (some combinations result in “switching” whereby alternate frames repetitively see alternate fragments but other fragments are repeatedly missed), then the third successive frame will see yet another different fragment of the message, and so forth. According to the terminology of WO2015/121155, this phenomenon is described by saying that the message is “rolling” with respect to the frame rate or frame period, or by saying that the “rolling condition” is met.

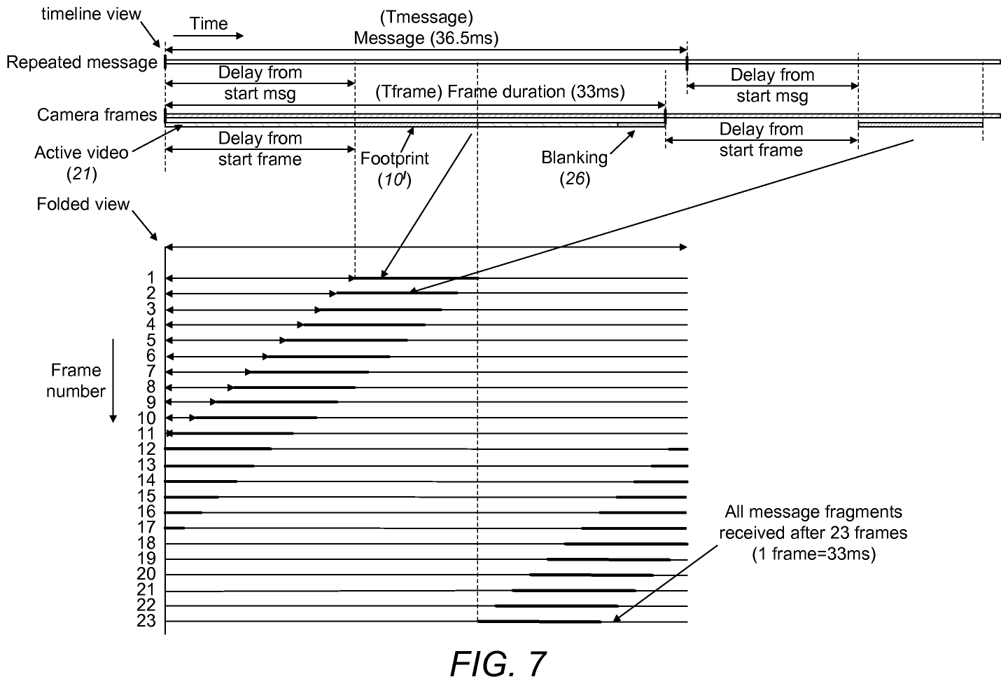

Another example is shown in FIG. 7. In this example the message period Tmessage is 36.5 ms and the frame period Tframe is 33 ms. The footprint ratio α=0.25. The message is continuously repeated and the camera 12 is capturing the footprint 10′ of the light source 10. Because the message period Tmessage differs from the frame period Tframe, the message appears to roll over the camera screen: at every frame a shifted part of the message is captured. In this example it would take 23 frames to get a complete message (23*33 ms=760 ms). There is quite some overlap in this example: meaning that parts of the message are captured more than once.

On the other hand, when the message period Tmessage is more-or-less the same as the frame period Tframe then the message is effectively not ‘rolling’. This means that the camera ‘sees’ (in the footprint area 10′) the same fraction of the message in every frame. Especially when the footprint 10′ is small then it can take a lot of frames to collect all the fractions needed to gather up a complete copy of the transmitted message. This effect happens also for other ratios of the message and frame period, such as “switching” combinations where one frame captures a first fragment of the message, then the next frame captures a second fragment of the message, but then the next frame after that captures the first fragment again, and so forth, such that parts of the message not covered by the first and second fragments are still never captured.

In general, if 1/(n+1)<α≤1/n, where n is an integer, then one encounters “non-rolling” footprints if:

$$\frac{{T}_{message}}{{T}_{frame}} ∈ \{ \frac{k}{m} \vert m = 1 , … , n , k ∈ {N}^{+} \}$$

where N⁺ is the set of all positive integers. Also, if the relationship is close to such a node, the message will roll or “drift” only very slowly with respect to the frame period, and so it will take a very long time to capture enough different fragments to reconstruct a message.

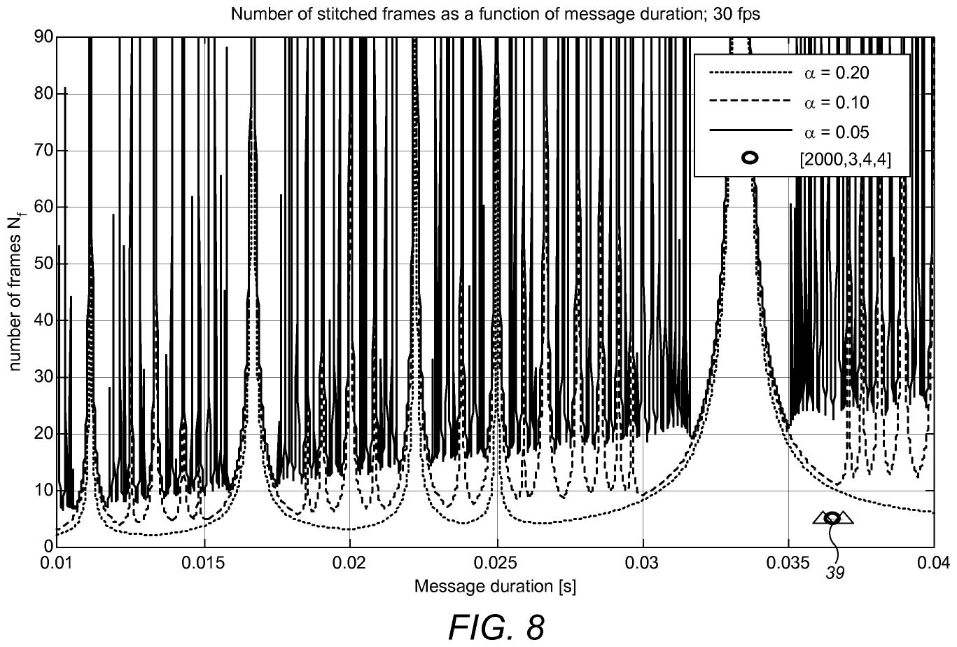

FIG. 8 shows some example plots of Nf as function of the message period Tmessage for a 30 fps camera, where Nf is the number of frames required to capture enough fragments to make up a compete message. The line with the fewest asymptotes indicates the number of frames needed to collect a message with a light source footprint ratio (α) of 0.2. The line with the second greatest number of asymptotes is for a footprint ratio α=0.1. The line with the most asymptotes is for a small footprint of α=0.05. For the larger footprint α=0.2 there are a few asymptotes, with a very wide one close to the frame period, but a lot of message periods would result in acceptable number of stitching frames. For the smaller footprints there will occur a lot of narrower asymptotes (with infinite detection times) that require careful selection of the message period.

In some systems the message period may be pre-designed for use with cameras 12 having a certain frame rate, such that for a minimum required footprint 10′, the number of frames for detection is acceptable (i.e. to avoid the asymptotes). The small black circle labelled 39 in the right bottom area of FIG. 8 indicates an example of such a working point for the message duration (36.5 ms). However, problems with detection may nonetheless occur when the clock of the driver 8 at the transmit side 2 is drifting a bit, or if the footprint 10′ is a bit smaller than designed for. In such cases the detection can become difficult, or even not possible at all, because the ratio of message period Tmessage to frame period Tframe becomes closer to one of the asymptotes. Furthermore, in other systems, it is not always possible to design a message period with a particular receiving frame rate in mind or vice versa. In such systems unfortunate coincidental combinations of Tmessage and Tframe may also happen to place their ratio at or close to one of the asymptotes.

In order to avoid such scenarios, then according to the present disclosure, the controller 13 is configured to monitor the number of frames that have elapsed so far without yet seeing a complete message, and if this exceeds a threshold, to adjust the size of the ROI and therefore the frame rate in order to avoid the above non-rolling condition (i.e. to avoid the asymptote that is being inadvertently approached). Thus the controller 13 can see a trend after a few frames and correct the ROI when needed.

Other alternative or additional criteria may also be used to trigger the adjustment. For instance, an equivalent to the above is to place a threshold on the decoding time: i.e. if beyond a threshold amount of time has elapsed without successful reconstruction of the message, the controller 13 adjusts the ROI size and thereby the frame rate so as to avoid non-rolling. Another possibility is for the controller 13 to compare the fragments of the message captured in successive frames in the captured sequence of frames: if the controller 13 detects that the fragments in two or more successive frames are too similar according to a predetermined similarity metric, then this is indicative of a non-rolling message and therefore in response the controller 13 triggers the adjustment of the ROI.

As an optional first step, the controller 13 uses the region-of-interest (ROI) setting of the camera 12 to increase the relative footprint a of the light source 10, in order to reduce the chance of the above-described effect. By selecting the ROI to just cover that part of the image where the light source 10 is ‘seen’ (Tsource), the framerate can be increased (so Tframe is smaller), and therefore the footprint ratio α becomes larger. Note that the total bandwidth from the camera 12 remains the same as without ROI selection. To make this work the camera 12 should be configured such that the pixels outside the ROI are not to be replaced by blanking (non-active video) because that would keep the frame rate constant.

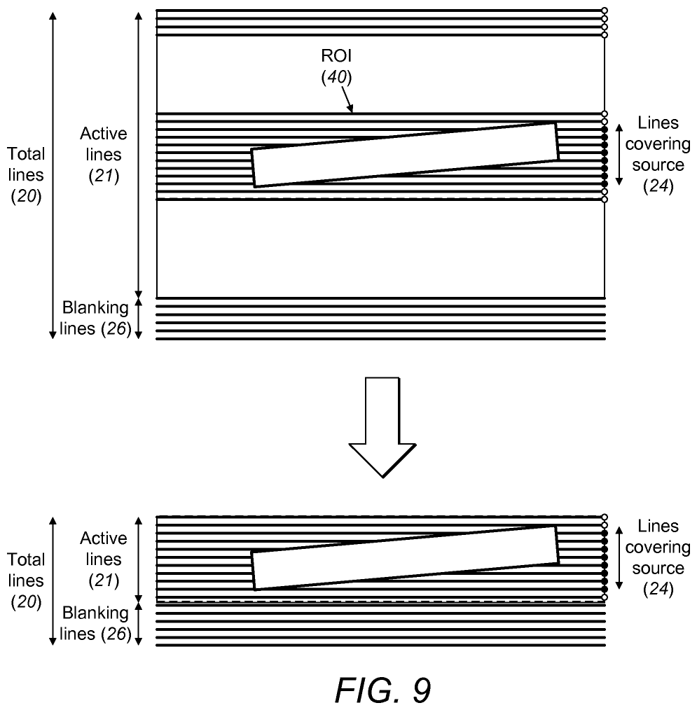

FIG. 9 illustrates an example of applying a ROI setting. The ROI 40 is selected to fit closely around the light source. That is to say, the controller 13 sets the ROI 40 so as to crop the frame area 16′ around the footprint 10′ of the light source 10 at least in the vertical direction (i.e. so as to reduce the number of lines 18 captured per frame 16′), preferably such that the footprint 10′ just fits inside the ROI 40 in the vertical direction. Note that for the effect desired here it is not required to adapt the horizontal size of the ROI 40, though that possibility is not excluded either.

Note that the detector 14 is configured to set the ROI 40 such that the footprint of the light source 10 is followed in the case of motion of the camera 12 (e.g. when the user walks underneath the luminaires). For this purpose suitable object tracking algorithms are in themselves known in the art.

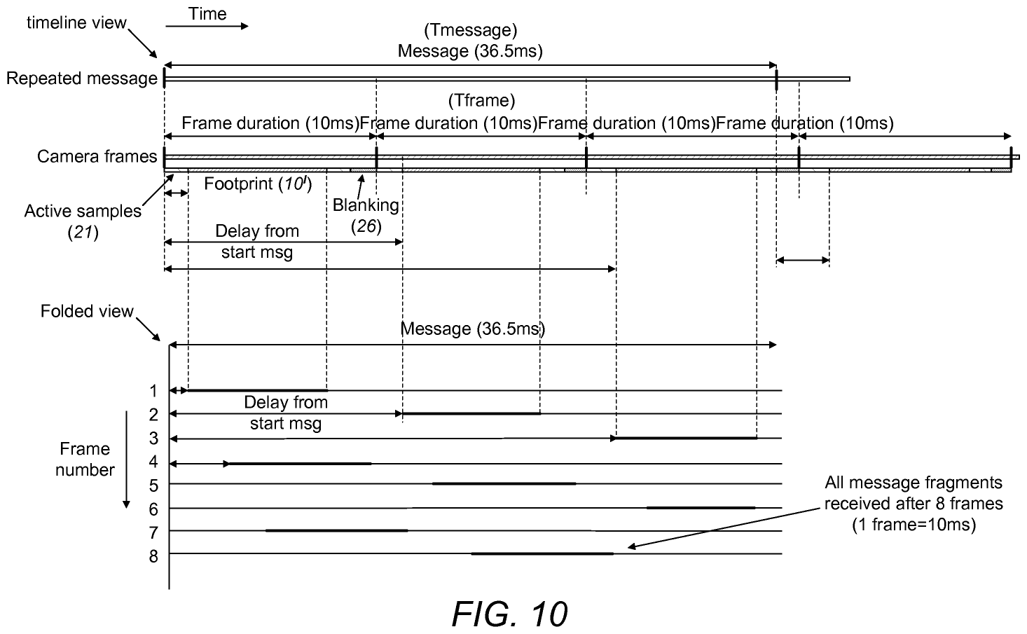

FIG. 10 illustrates the corresponding timing of the message capture when the ROI settings are applied. The relative footprint a (i.e. as a ratio of the frame height) is now ˜0.65. In this example a is not closer to 1 because of the blanking area 26, though blanking is not always present so in other scenarios the relative footprint a can be close to 1. Accordingly the frame duration drops from 33 ms to 10 ms and the full message is captured in eight frames. Because of the shorter frame period this would mean message capture in 80 ms. Compared to the original 760 ms this is a lot faster.

However, as discussed, in practice the detection speed increase due to ROI selection depends on the rolling behavior for the particular combination of frame rate and message duration. I.e. one does not necessarily achieve a speed increase—and may even get a decrease—if the selected ROI 40 accidentally causes the corresponding frame rate to hit or approaches one of the non-rolling asymptotes.

To avoid this, then in a second step in accordance with embodiments disclosed herein, the controller 13 adapts the vertical size of the ROI 40 (i.e. the number of lines 18). Thus the controller 13 of the detector 14 can influence the framerate and therefore the rolling behavior of the message.

Alternatively or additionally, the controller 13 may adapt the horizontal size of the ROI 40. This can also influence the framerate since in some implementations the time required to readout a line 18 is dependent on the length of the line. Therefore in embodiments the rolling behavior of the message can be altered by adjusting the horizontal size of the ROI 40 (as an alternative or in addition to adapting the vertical size, i.e. number of lines read out). See again for example FIG. 2a. In embodiments the time to readout a frame is given by:

Frame Time=((PPL/RATE)+RBT)×LPF

where PPL=pixels per line, RATE is the frame rate (1/Tframe), RBT=row blanking time, and LPF=lines per frame.

What is the limiting factor on the framerate depends on the actual sensor hardware. In some cases the pixel clock (i.e. pixel rate) itself cannot be varied, in which case the only way to increase the framerate is using the ROI. In other cases the pixel clock of the camera can be changed to change the frame rate. However, changing the ROI to speed-up the frame rate is much more efficient because only relevant data needs to be read from the camera. When the pixel clock is increased than the bandwidth on the camera interface also increases and that is not always possible, or even allowed (e.g. in many smartphones), for instance because this has not been tested for EMC (electromagnetic compatibility) or such like. When the ROI is adapted on the other hand, the basic camera timing can remain the same.

To implement the adaptation, in embodiments the controller 13 is configured to monitor the number of frames that have so far been captured since the start of a new attempt to detect a message (e.g. since turning on the detection process or since the last successful detection) without yet accumulating enough message fragments to reconstruct a copy of the entire coded light message. The controller 13 can do this by knowing the line rate and the frame rate of the camera 12, based upon which it can calculate the delay between the fragments collected per frame and stitch them together. The message's length is also predetermined and known by the controller 13, and therefore it can calculate the progress towards reconstructing a complete message.

Further, the controller 12 is configured to adapt the ROI 40 in dependence on the current number of frames captured so far without completing the message. For instance, in embodiments, the controller 13 is configured to compare the current number of frames to a threshold, and if the number exceeds this threshold (or equivalently reaches a threshold of one higher) then the controller 13 takes measures to avoid this apparently non-rolling behavior by adjusting the vertical and/or horizontal size of the ROI 40 (the size the direction perpendicular and/or parallel to the lines 18 in the plane of the frame 16′).

As an equivalent to this, the controller 13 is configured to monitor the time that has elapsed so far since the start of a new attempt to detect a message (e.g. since turning on the detection process or since the last successful detection) without yet accumulating enough message fragments to reconstruct a copy of the entire coded light message. The controller 13 is configured to then adapt the ROI 40 in dependence on the currently elapsed time. For instance, in embodiments, the controller 13 is configured to compare the current elapsed time to a threshold, and if the elapsed time exceeds threshold (or equivalently reaches a threshold) then the controller 13 takes measures to avoid this apparently non-rolling behavior by adjusting the vertical and/or horizontal size of the ROI 40.

As another possibility, the controller is configured to compare the message fragments from two or more successive frames in the sequence of captured frames, or more generally to compare two or more frames within a predetermined number of frames of one another (i.e. two or more frames that are “nearby” to one another”). The comparison may be based on any suitable metric measuring similarity. Such metrics for measuring signal similarity are in themselves known in the art, e.g. correlation. In such embodiments, the controller 13 is configured to determine whether the measured degree of similarity between the message fragments from the compared frames is beyond a threshold, and if so to trigger the adjustment of the ROI 40 (again to avoid this apparently non-rolling behavior).

Note: to get away from a non-rolling asymptote, it does not necessarily matter whether the adjustment is an increase or a decrease or what the magnitude of the adjustment is. The non-rolling asymptotes are very steep, so a small change of the framerate in either direction will usually be enough to get away from it. As the message first begins to be received, the controller 13 does not know upfront how long reconstruction is going to take at the current rate and therefore cannot necessarily calculate analytically what adjustment to make to avoid the wrong combination of Tmessage and Tframe. Instead, the controller 13 infers from that fact that a complete message has not been received for a relatively long time that the combination of Tmessage and Tframe is at or near an asymptote. To get away, it then tries out an adjustment to the frame rate via an adjustment to the ROI 40. This adjustment may comprise increasing or decreasing the size by a predetermined amount, or a random amount, or an amount that depends on one or more circumstances such as the current monitored number of frames that have already been accumulated without success (so the adjustment increases in magnitude the longer the reconstruction is taking). In the latter case therefore, instead of a strictly binary threshold behavior, in some embodiments the controller 13 could also adapt by degree. I.e. the controller 13 first makes a small adjustment to the ROI 40, and then if this initial small adjustment is still not yielding a complete message after a certain number of frames, the controller 13 makes another small adjustment, and so forth.

Alternatively or additionally, the way the fragments are coming in can reveal some information. That is, when then the rolling properties are not optimum, the fragments collected from consecutive frames may have a lot of overlap. Nonetheless, the coded light detector 14 may still be able to analyze the received fragments to estimate the transmitter clock relatively quickly (in fact this estimating in itself benefits from the overlap because the correlation works well). From the estimated clock and the known frame rate, in embodiments the controller 13 can calculate the rolling asymptotes or fetched them from memory (being pre-calculated). Based on these, the controller 13 can then calculate an amount and/or direction for the adaptation.

Note that while in the above-described scheme, the controller 13 first select ROI 40 to fit closely around the footprint 10′ and then adapts that ROI 40, the first step not essential in all possible embodiments. Alternatively the process could begin with full frame capture, or an ROI 40 or cropped frame format selected on some other basis, and then adapt this if a non-rolling scenario is experienced. For instance this may be useful for arrangements in which the message period has not been specially designed to complement the camera frame rate.

In further, optional embodiments, the controller 13 may be configured to adapt the ROI 40 on one or more additional bases in order to improve the coded light detection even further.

For instance, the controller 13 may be configured to keep at least one boundary visible above and/or below the footprint 10′ of the light source 10 on the horizontal axis, in order to leave some headroom to detect horizontal camera motion and thereby enable robust tracking. A similar strategy can be applied with more vertical oriented luminaires in the image. As mentioned, the detector 14 is configured to track the footprint 10′ within the frame area 16′ using an object tracking algorithm. In embodiments, the object tracking algorithm may work based on detecting edge portions of the footprint 10, or may simply work better given a full image of the footprint 10′. However, if the ROI 40 is set to fit exactly around the footprint 10 with no margin whatsoever, then when the footprint 10′ moves within the frame area from one frame to the next, then an edge portion of the footprint will be lost just outside the ROI 40. Therefore to accommodate for this, in embodiments the controller 13 is configured set the ROI 40 so as to leave a small margin around the footprint 10′. In embodiments the margin is left all the way around the footprint 10′. Alternatively the controller 13 could leave a margin only along one side, in a direction in which the controller 13 anticipates the footprint 10′ is heading based on its current tracked trajectory.

Note that the size of the margin is not fixed. Rather it is adapted by the controller 13 when a non-rolling scenario is encountered.

In further embodiments, the controller 13 may be configured to adapt the horizontal size of the ROI 40 in dependence on the signal-to-noise ratio (SNR) of the received VLC code, by reducing the horizontal size when the SNR is high but increasing the horizontal size when the SNR is low. Consider again FIG. 4. Summing all the pixels in the horizontal direction will increase SNR. However, when the signal quality is very high, it is possible to limit the summing of pixels in horizontal direction to fewer pixels, and thus increasing the framerate to improve the rolling behavior. Note: this is true for coded light detection, but also in embodiments 2D signal processing may be involved for segmentation and/or motion compensation (tracking) that needs to ‘see’/image the whole object.

Moreover, presented strategies could be combined with subsampling or binning features often supported by state-of-the-art imagers which influence the framerate and therefor the rolling behavior of the message. For instance, in case of a subsampling factor of two, the pixels on the row and columns are skipped. This results in four times less data to be read out and for many imagers the framerate is influenced. The same applies for binning (i.e. combining pixels into larger bins, such as by averaging or summing the pixels of each bin). Hence in embodiments, the controller 13 may be configured to adapt the size of the ROI by adapting a subsampling or binning factor.

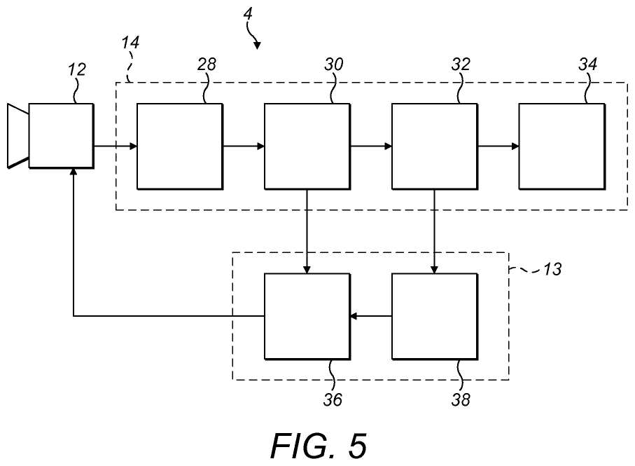

An example architecture for implementing the receiver 4 is illustrated in FIG. 5. As shown, the coded light detector comprises a blob detector 28, a blob selector 30, a stitching block 32, and a decoder 34. The controller 13 comprises an ROI selection block 36 and a stitch completion monitor 38.

For the first (optional) step of increasing the effective footprint a by means of the ROI setting, the detector 14 needs to detect the blobs in the camera image 16′ that are potential luminaires with VLC. For this operation the ROI selector 36 of the controller 13 begins by setting the camera 12 to normal mode (without ROI selection). The blob detector 28 receive one or more frames 16′ captured by the camera 12. The blob detector 28 comprises a computer vision algorithm configured to detect one or more “blobs” of light, i.e. to detect the footprint 10′ of one or more light sources 10. One possible implementation can be that one of the blobs should be selected as target for further detection. Hence in embodiments the detector 14 comprises the blob selector 30 which selects one of these blobs to work on, i.e. to process for coded light detection. The ROI selector 36 then sets the ROI 40 of the camera 12 closely around the blob area of the selected blob (i.e. to just fit around the selected footprint 10′).

There are many different suitable computer vision approaches that can be used for the above part of the process, such as blob analysis, contour analysis or other shape recognition techniques combined with object tracking to localize and track the luminaire 10 to predict the location and size of the ROI 40.

The stitching block 32 is configured to collect the fragments of the coded light message appearing in the selected blob of light 10′ over multiple frames, and to “stitch” together these message fragments into a complete message, e.g. using the techniques taught in WO2015/121155. The reconstructed waveform is then passed to the decoder 34 in order to extract the meaning of the message.

Once the VLC detector 14 has found a valid code in the currently selected blob 10′, then the ROI selector 36 switches the camera 12 back to full image mode. If the detector 28 has detected more than one light source in the image, then the next blob can be selected and the process repeated for that blob. Alternatively, if the camera 12 supports multiple simultaneous ROIs 40, an alternative to processing multiple blobs 10′ in turn is to set a respective ROI for each blob (i.e. each light source footprint) and process the respective message from each in parallel.

Note again: when the camera 12 moves during detection it is useful to select a ROI 40 with some extra margin to enable to follow the source without adapting the ROI (which is faster because the camera 12 does not need to be set and waiting for propagation through video pipeline is not needed). For larger movement some additional adaptation of the ROI 40 might be still needed.

For the step of adapting the ROI 40 to optimize the rolling behavior, the detector 14 generates a control signal to the ROI selection block 36. This control signal is delivered by the stitching monitor 38 which is configured to monitor the collected fragments of the message. When it is thus determined that some parts of the message are not seen, then the ROI selector 36 slightly increases or decreases the ROI. This can be done feedforward by applying a ROI size change depending on the gap size, or with a feedback loop that changes the ROI size until the stitching gets completed.

Some imagers have double register banks or support multiple ROIs to switch the imager read-out between successive images. This enables us to anticipate on the expected or tracked motion and prepare the imager quickly to adapt the ROI when the luminaire is moving outside the original ROI. That is, in embodiments, the controller 13 may define a new ROI which is larger than the current ROI 40. Then, based on the expected motion, the controller 13 may determine that the footprint 10′ of the tracked illumination source 10 will be partially outside the ROI. Based on this determination, the controller 13 can then switch to the larger ROI.

The disclosed techniques can be used in a variety of applications, such as personal light control and indoor positioning in which identifiers are received from luminaires embedded in the illumination emitted by the luminaires. E.g. in this way the lighting infrastructure can be used as a dense beacon network.

It will be appreciated that the above embodiments have been described only by way of example. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Apparatus for detecting a message transmitted periodically in light emitted by a light source, the apparatus comprising:
a detector configured to receive a series of frames captured at a frame rate by a rolling-shutter camera, each frame capturing an image of the light source, wherein the rolling-shutter camera captures each of the frames over a range of sequentially captured lines such that each line captures a respective sample of the message and each frame captures a respective fragment of the message made up of a respective subsequence of the samples, and wherein the detector is configured to reconstruct the message from the fragments captured over a plural number of said frames; and
Characterized in that the apparatus further comprises:
a controller operable to set a region of interest of the rolling-shutter camera, wherein the frame rate of the rolling-shutter camera is dependent on a size of the region of interest;
wherein the controller is configured to evaluate a metric indicative of how long will be required to accumulate enough of said fragments to reconstruct the message at a current value of said frame rate, and to adapt the region of interest in dependence on the evaluated metric in order to change the frame rate and thereby reduce the number of subsequent frames required to complete the reconstruction of the message.

2. The apparatus of claim 1, wherein said metric comprises a current number of said frames that have been captured, or a time that has currently elapsed, without yet accumulating enough of said fragments to allow for said reconstruction of the message.

3. The apparatus of claim 1, wherein said metric comprises a measure of similarity between the message fragments from two or more of said frames within a predetermined number of frames of one another in said series.

4. The apparatus of claim 1, wherein the controller is configured to perform said adaption of the region of interest by adapting a size of the region of interest in a direction perpendicular to the lines, thereby adapting the range of lines captured per frame.

5. The apparatus claim 1, wherein the controller is configured to perform said adaption of the region of interest by adapting a size of the region of interest in a direction parallel to said lines.

6. The apparatus of claim 1, wherein the controller is configured to perform said adaption of the region of interest by adapting a subsampling or binning ratio of the frames.

7. The apparatus claim 1, wherein the controller is further configured to adapt the size of the region of interest perpendicular to said lines in dependence on a signal to noise ratio of the reconstructed message.

8. The apparatus of claim 1, wherein the controller is configured to initially set the region of interest to an initial region of interest which crops the frames around a footprint of the light source in at least a direction perpendicular to said lines; and to perform said monitoring under conditions of the initial region of interest, said adaption being relative to the initial region of interest.

9. The apparatus of claim 8, wherein the controller is configured to control the region of interest so as, before and after said adaption, to leave a margin around at least part of the footprint; and wherein the controller is configured to track the footprint of the light source at least partially based on part of the footprint moving into the margin in a successive one of said frames.

10. The apparatus of claim 9, wherein the controller is configured to leave said margin all around the footprint.

11. The apparatus of claim 8, wherein the camera supports multiple regions of interest, and wherein the controller is configured to track motion of the footprint at least in part by using the multiple regions of interest to anticipate the tracked motion.

12. Receiver equipment comprising the apparatus claim 1 and further comprising the camera.

13. A system comprising the receiving equipment of claim 12 and further comprising transmitting equipment, the transmitting equipment comprising said light source.

14. A method of detecting a message transmitted periodically in light emitted by a light source, the method comprising:
receiving a series of frames captured at a frame rate by a rolling-shutter camera, each frame capturing an image of the light source, wherein the rolling-shutter camera captures each of the frames over a range of sequentially captured lines such that each line captures a respective sample of the message and each frame captures a respective fragment of the message made up of a respective subsequence of the samples; and
reconstructing the message from the fragments captured over a plural number of said frames;
characterized in that:
the frame rate of the rolling-shutter camera is dependent on a size of the region of interest; and
the method further comprises evaluating a metric indicative of how long will be required to accumulate enough of said fragments to reconstruct the message at a current value of said frame rate, and adapting the region of interest in dependence on the evaluated metric in order to change the frame rate and thereby reduce the number of subsequent frames required to complete the reconstruction of the message.

15. A computer program product for detecting a message transmitted periodically in light emitted by a light source, the computer program product comprising code embodied on computer-readable storage and/or being downloadable therefrom, and being configured so as when run on a processing apparatus comprising one or more processing units to perform operations of:
receiving a series of frames captured at a frame rate by a rolling-shutter camera, each frame capturing an image of the light source, wherein the rolling-shutter camera captures each of the frames over a range of sequentially captured lines such that each line captures a respective sample of the message and each frame captures a respective fragment of the message made up of a respective subsequence of the samples; and
reconstructing the message from the fragments captured over a plural number of said frames;
characterized in that:
frame rate of the rolling-shutter camera is dependent on a size of the region of interest; and
the code is further configured so as when run on the processing apparatus to evaluate a metric indicative of how long will be required to accumulate enough of said fragments to reconstruct the message at a current value of said frame rate, and to adapt the region of interest in dependence on the evaluated metric in order to change the frame rate and thereby reduce the number of subsequent frames required to complete the reconstruction of the message.
